(19) United States
(12) Patent Application Publication
(10) Pub. No.: US 2006/0166806 A1
(43) Pub. Date: Jul. 27, 2006

(54) Antimicrobial sulfophosphate glass

(76) Inventors: Jorg Fechner, Mainz (DE); Jose Zimmer, Ingelheim (DE); Karine Seneschal, Mainz (DE)

Correspondence Address: BAKER & DANIELS LLP;111 E. WAYNE STREET, SUITE 800, FORT WAYNE, IN, 46802, US

(21) Appl. No.: 10/546,664

(22) PCT Filed: Feb. 19, 2004
(86) PCT No.: PCT/EP04/01572

§ 371 Date: Aug. 23, 2005

(30) Foreign Application Priority Data
Feb. 25, 2003 (DE) 103 08 227.1

(51) Int. Cl. C03C 3/16

(52) U.S. Cl. 501/45

(57) ABSTRACT

The invention relates to an antimicrobial and anti-inflammatory sulfophosphate glass having the following composition in percent by weight on an oxide basis: P₂O₅ 15-60 percent by weight; SO₃ 5-40 percent by weight; B₂0₃ 0-20 percent by Al₂O₃ 0-10 percent by weight; SiO₂ 0-10 percent by weight; Li₂O 0-25 percent by weight; Na₂O 0-25 percent by weight; K₂O 0-25 percent by weight; CaO 0-40 percent by weight; MgO 0-15 percent by weight; SrO 0-15 percent by weight; BaO 0-15 percent by weight; ZnO 0-45 percent by weight; Ag₂O >0.01-5 percent by weight; CuO 0-10 percent by weight; GeO₂ 0-10 percent by weight; TeO₂ 0-15 percent by weight; Cr₂O₃ 0-10 percent by weight; J 0-10 percent by weight; F 0-5 percent by weight, the sum ZnO+Ag₂O+CuO+GeO₂+TeO₂+Cr₂O₃+J ranging from >0.01 to 45 percent by weight.

The invention relates to antimicrobial glasses, glass ceramics, in particular glass powder and glass ceramic powder, glass fibers, glass granules and glass pellets based on sulfophosphate glasses which exhibit an antimicrobial effect.

U.S. Pat. No. 5,544,695 describes sulfophosphate glasses with low glass transition temperature for application as intumescent flame retarders and/or smoke retarders for polymers. The glasses exhibit a low hydrolytic resistance. A usage of these glasses without polymer matrix, in particular an antimicrobial effect is not mentioned in U.S. Pat. No. 4,544,695.

EP 0 648 713 specifies a zinc sulfophosphate glass which exhibits a low glass transition temperature and a high chemical, in particular hydrolytic resistance in a glass-plastic polymer matrix. The glasses described in EP 0 648 713 are used exclusively in glass-plastic compositions. An antimicrobial effect is not described.

Glass-plastic compounds are known from DE-A-19960548, said compounds comprising a low-melting sulfophosphate glass as well as a high performance thermoplastic. The sulfophosphate glasses are similar to those known from EP 0 648 713 and comprise a high ZnO content. Only usage in glass-plastic compounds is described. An antimicrobial effect is not mentioned.

A glassy or glass crystalline material with the following composition is known from DD 302 011 A: CaO 20-55 percent by weight, Na₂O 5-25 percent by weight, K₂O 0.01-0-15 percent by weight, MgO 0-15 percent by weight, P₂O₅ 30-50 percent by weight, SiO₂ 0-15 percent by weight, Na₂SO₄ and/or K₂SO₄ 0-40 percent by weight, which depending on cooling conditions can be maintained glassy or glass crystalline. In the case of the material known from DD 302 011 A only a batch is described. The sulfate content is only loading material, but not a component of the glass network.

In the case of glass ceramics the sulfur remains in the crystalline phase glaserite. Moreover the material known from DD 302 011 A does not exhibit an antimicrobial effect.

GB 2,178,422 describes a phosphate glass which can also contain zinc and in which a maximum of 5% mol of the glass-forming oxide P₂O₅ can be replaced by SO₄.

A maximum content of 5% mol is too little to set a neutral pH value of the glass powder in contact with water. Further the sulfate synergistically supports the antimicrobial effect with contents >5% mol. Via the sulfur, which contributes to the structure of the glass network, the processing temperatures of the glass are reduced. The processing can thus take place at low temperatures.

The object of the invention is to specify a glass composition which exhibits an antimicrobial effect, a hydrolytic resistance meeting the requirements as well as an appropriate reactivity. In particular the glass should stand out due to low melting conditions.

This object is solved by means of a glass composition in accordance with Claim 1 or Claim 2, a glass ceramic in accordance with Claim 9 or a glass powder or glass ceramic powder in accordance with one of Claims 10.

The inventive glass compositions stand out in particular due to an SO₃ content greater than 5 percent by weight, particularly greater than 6 percent by weight, in particular greater than 7 percent by weight, in particular preferably greater than 9 percent by weight, in particular preferably greater than 11 percent by weight as well as standing out due to the fact that the SO₃ is a network forming ion together with P₂O₅ and is incorporated in the glass matrix of the glass or of the vitreous phase of the glass ceramics. The high content in SO₃ has the advantage that the glass exhibits very low melting temperatures. For one thing, this condition results in the reduction in energy use compared to known glasses and in particular in usage as an antimicrobial loading agent to polymers melting these together with the polymers, which results in an intimate bond between the antimicrobial loading agent on the basis of the sulfate glass and the polymer.

For example sulfophosphate glasses show a Tg of approximately 270-280° C. and hence are approximately 20-30° C. lower than comparably pure phosphate glasses with corresponding chemical resistance.

The addition of Zn with content greater than 1 percent by weight, in particular more than 5 percent by weight, in particular more than 10 percent by weight ZnO, in particular preferably more than 24 percent by weight, especially preferably more than 30 percent by weight ZnO supports the antimicrobial effect. In particular with ZnO content of more than 24 percent by weight, especially preferably with more than 30 percent by weight a surprisingly strong antimicrobial effect ensues. The usage of Zn as an antimicrobial additive has the further advantage that regardless of the manner in which the method is performed a discoloration is prevented.

The inventive glasses or glass ceramics, glass powders or glass ceramic powders obtained from them possess a slightly acid, skin-neutral pH value of approximately 5.5 to a neutral pH value of 7.0. A neutral pH value of 7.0 is especially preferable.

The addition of silver quite often results in a discoloration of the glass. Such a discoloration can be prevented when silver is added to the glass in the batch in the form of oxidative effective form, e.g. as silver nitrate (AgNO₃). Additionally the glass is preferably melted under oxidizing conditions, e.g. by means of oxygen bubbling, in order to achieve an oxidizing state in the glass and consequently prevent a reduction of the Ag⁺ to metallic Ag⁰. In the case of such a performed method in the addition of silver a discoloration can be prevented both in the glass as well as also in the further processing in the polymer. Also other components such as e.g. alkalis, alkaline earth can be preferably added as nitrates.

The overall nitrate content in the raw materials batch amounts to preferably more than 0.5 or 1.0 percent by weight, especially preferably more than 2.0, and most preferably more than 3.0 percent by weight.

The glass composition or the glass ceramics or glass powders or glass ceramic powders obtained from it are toxicologically generally recognized as safe for use in cosmetics/medicine/food processing and are free from heavy metals with the exception of Zn.

They can be used for preservation of the products themselves as well as for achieving an antimicrobial effect outward, i.e. a release of antimicrobial active substances, in particular ions such as zinc. Ag can also be used as an antimicrobial additive.

The toxicological quality of being generally recognized as safe is not a condition for the use of glass compositions or glass ceramics or glass powders or glass ceramic powders in order to make available an antimicrobial/biocide effect in products except for polymers such as paints and enamels. In this case the composition can contain Cr₂O₃ or CuO.

The inventive glass compositions or glass ceramics or glass powders or glass ceramic powders can be used for preservation of the products themselves and/or for the achievement of an antimicrobial effect outwards, i.e. of a release of antimicrobial acting substances, in particular ions such as e.g. zinc or silver.

The glass, the glass ceramic obtained from it as well as the glass powder or glass ceramic powder obtained from the glass in the case of sufficient hydrolytic stability can also be applied to a polymer as a protective coating or coating.

Because the glass composition of the invention exhibits anti-inflammatory and wound healing properties, it is in particular also well suited for use in the fields of cosmetics, medicine.

In a first embodiment the inventive glass composition comprises the following components, in percent by weight on an oxide basis:

| | | |
|---|---|---|
| P₂O₅ | 15-60 | percent by weight |
| SO₃ | 5-40 | percent by weight |
| B₂0₃ | 0-20 | percent by weight |
| Al₂O₃ | 0-10 | percent by weight |
| SiO₂ | 0-10 | percent by weight |
| Li₂O | 0-25 | percent by weight |
| Na₂O | 0-25 | percent by weight |
| K₂O | 0-25 | percent by weight |
| CaO | >7.7-45 | percent by weight |
| MgO | 0-15 | percent by weight |
| SrO | 0-15 | percent by weight |
| BaO | 0-15 | percent by weight |
| ZnO | 0-45 | percent by weight |
| Ag₂O | 0-5 | percent by weight |
| CuO | 0-10 | percent by weight |
| GeO₂ | 0-10 | percent by weight |
| TeO₂ | 0-15 | percent by weight |
| Cr₂O₃ | 0-10 | percent by weight |
| J | 0-10 | percent by weight |
| F | 0-5 | percent by weight |

whereby the sum ZnO+Ag₂O+CuO+GeO₂+TeO₂+Cr₂O₃+J ranges from >0.01 to 45 percent by weight.

This embodiment is especially well suited for use in cosmetic and medical products. In such applications as a result of the zinc an antimicrobial and in particular anti-inflammatory effect is achieved. Additionally the glass contains CaO contents >7.7 percent by weight. This is most particularly preferred, because as a result of this a special compatibility with body tissue is achieved. In a most especially preferred embodiment as a result of the joint presence of CaO and P₂O₅ in the case of reaction with water or body fluid a Ca-apatite or hydroxyl apatite coating can form in the glass matrix. This embodiment is preferably free from heavy metals with the exception of zinc. Slight Ag₂O contents of less than 1.0 percent by weight can be included for the achievement of specific effects, e.g. the strengthening of the antimicrobial effect.

The glasses or the glass ceramics, glass powders or glass ceramic powders obtained from said glasses possess a slightly acid, skin-neutral pH value of approximately 5.5 to a neutral pH value of 7.0.

The first embodiment is particularly well suited for use in creams or lotions or similar offerings for application on the skin.

Possible applications in the field of medicine are the reduction or prevention of skin irritations such as erythema, irritation, as well as caring for wounds in the cosmetic and medical fields.

Another field of application is food preservation as well as the field of food processing.

In a second embodiment of the invention a glass composition comprising the following components is made available:

| | | |
|---|---|---|
| P₂O₅ | 15-60 | percent by weight |
| SO₃ | 5-40 | percent by weight |
| B₂0₃ | 0-20 | percent by weight |
| Al₂O₃ | 0-10 | percent by weight |
| SiO₂ | 0-10 | percent by weight |
| Li₂O | 0-25 | percent by weight |
| Na₂O | 0-25 | percent by weight |
| K₂O | 0-25 | percent by weight |
| CaO | 0-40 | percent by weight |
| MgO | 0-15 | percent by weight |
| SrO | 0-15 | percent by weight |
| BaO | 0-15 | percent by weight |
| ZnO | 0-45 | percent by weight |
| Ag₂O | >0.01-5 | percent by weight |
| CuO | 0-10 | percent by weight |
| GeO₂ | 0-10 | percent by weight |
| TeO₂ | 0-15 | percent by weight |
| Cr₂O₃ | 0-10 | percent by weight |
| J | 0-10 | percent by weight |
| F | 0-5 | percent by weight |

whereby the sum ZnO+Ag₂O+CuO+GeO₂+TeO₂+Cr₂O₃+J ranges from >0.01 to 45 percent by weight.

In a preferred embodiment of the invention the glass composition exhibits more than 5 percent by weight ZnO, in particular more than 10 percent by weight ZnO, in particular preferably more than 24 percent by weight, especially preferably more than 30 percent by weight.

The Ag content in these glasses ranges from 0.01 to 5 percent by weight, in particular ranging from 0.1 to 5 percent by weight or ranging from 0.2 to 2 percent by weight.

One preferred application field of the glasses or the glass ceramics, glass powders or glass ceramic powders obtained from the glasses in accordance with the alternative embodiment of the invention is the use in polymers for the achievement of a biocidal or biostatic effect. For one thing a preservation of the polymer itself can be in the foreground, i.e. protecting the polymer from bacteria and fungal attack. In addition a biostatic or biocidal polymer surface can be created herewith, whereby if possible no biocidal active substances e.g. ions are to be transferred to the environment. An additional objective can be the provision of a polymer which in particular releases biocidally active substances.

In the case of a use of such a glass composition or glass ceramics or glass powders or glass ceramic powders made from such glass compositions in polymers it is expected that due to the shielding of aqueous media they will be only insufficiently antimicrobial, because they are encapsulated by polymers. Surprisingly it turns out that even by the addition of very slight quantities of Ag and/or other biocidal ions such as Zn, Cr, Cu, a significant antimicrobial effect of the glass, the glass ceramic, of the glass powder or of the glass ceramic powder occurs.

This is surprising because very slight water content in conventionally manufactured polymer is already sufficient to “activate” the silver ions and/or other biocidal ions in the glass matrix, and hence achieve an antimicrobial long-term effect.

A further developed embodiment of the invention provides that the glass composition also comprises Ca and Zn and that the sum of CaO and ZnO in this glass composition ranges from 20-60 percent by weight.

As stated earlier, the glasses with the inventive compositions or glass ceramics, glass powders or glass ceramic powders obtained from said compositions evince a biostatic or biocidal effect in polymers. This can be used to preserve polymers, in particular protecting them from fungal attack or decomposition by bacteria. It is also conceivable to equip a polymer with an antimicrobial surface. Such an antimicrobial surface if at all possible should not release or transfer any antimicrobial active substances, in particular ions, outward, i.e. outside of the polymer surface.

The inventive glasses also make possible a slow release of antimicrobial active ions from a polymer matrix. In the process the water content of the polymer as well as the diffusion of the mobile ions in the polymer matrix play a deciding role. In general the biocidal ion content in the glass matrix or the concentration of glass in the polymer is higher than in the afore-mentioned application. This release can be combined with a partial or complete melting of the glass. In a particularly preferred embodiment the polymer matrix dissolves either partially or completely. In particular this is the case when the polymer matrix is water-soluble.

A further developed embodiment of the invention provides that the glass, the glass ceramic obtained from it as well as the glass powder or glass ceramic powder obtained from the glass in the case of sufficient hydrolytic stability is not contained in the polymer itself, but rather can also be applied to the polymer as a protective coating or coating.

To ensure a compatibility with the polymer and to set the reactivity the amount of CaO is preferably more than 1 percent by weight, preferably more than 7.7 percent by weight. One further advantage of a CaO content greater than 1 percent by weight lies in the increase of the temperature load capacity of the glass.

Further fields of application of the glasses described here are use in paints and enamels. The objective is preservation of the paints and/or achievement of a biocidal/biostatic layer or a biocidal effect outward, e.g. when a surface has mildewed.

In a particularly suitable embodiment of the invention the composition of the antimicrobial sulfophosphate glass contains in the following composition range (in percent by weight on an oxide basis)

| | |
|---|---|
| P₂O₅ | 30-40 percent by weight |
| SO₃ | 10-20 percent by weight |
| Na₂O | 10-20 percent by weight |
| CaO | 2-40 percent by weight |
| ZnO | 0-40 percent by weight |
| Ag₂O | 0-1 percent by weight |

Especially preferred is a composition which contains the following composition ranges (in percent by weight) on an oxide basis:

| | |
|---|---|
| P₂O₅ | 30-40 percent by weight |
| SO₃ | 10-20 percent by weight |
| Na₂O | 10-20 percent by weight |
| CaO | 2-10 percent by weight |
| ZnO | 24-35 percent by weight |
| Ag₂O | 0-1 percent by weight |

A non-discoloring silver-free composition contains the following composition ranges:

| | |
|---|---|
| P₂O₅ | 30-40 percent by weight |
| SO₃ | 10-20 percent by weight |
| Na₂O | 10-20 percent by weight |
| CaO | 2-40 percent by weight |
| ZnO | 0-40 percent by weight |

Especially preferred are inventive glasses with the above listed compositions which contain Ca and Zn in the ratio of 1:1 to 1:2 percent by weight. If Ca and Zn are included in the ratio of 1:1 to 1:2 percent by weight, this glass stands out due to an especially good biocompatibility, i.e. compatibility.

The above cited compositions can also contain iodine in the range of 0-1 percent by weight and Cr₂O₃ in the range of 0-1 percent by weight. By the addition of iodine a wound-healing and disinfecting effect is achieved.

Chromium is used in fields of application in which a toxicological quality of being generally recognized as safe is of lesser importance and a high antimicrobial effect is desired.

The production of glass ceramics made of the glass composition cited in the present application is also possible.

In addition the invention makes available the use of a glass, a glass ceramic, a glass ceramic powder or a glass with a composition in percent by weight on an oxide basis

| | | |
|---|---|---|
| P₂O₅ | 15-60 | percent by weight |
| SO₃ | 5-40 | percent by weight |
| B₂0₃ | 0-20 | percent by weight |
| Al₂O₃ | 0-10 | percent by weight |
| SiO₂ | 0-10 | percent by weight |
| Li₂O | 0-25 | percent by weight |
| Na₂O | 0-25 | percent by weight |
| K₂O | 0-25 | percent by weight |
| CaO | 0-40 | percent by weight |
| MgO | 0-15 | percent by weight |
| SrO | 0-15 | percent by weight |
| BaO | 0-15 | percent by weight |
| ZnO | 0-45 | percent by weight |
| Ag₂O | 0-5 | percent by weight |
| CuO | 0-10 | percent by weight |
| GeO₂ | 0-10 | percent by weight |
| TeO₂ | 0-15 | percent by weight |
| Cr₂O₃ | 0-10 | percent by weight |
| J | 0-10 | percent by weight |
| F | 0-5 | percent by weight |

whereby the sum ZnO+Ag₂O+CuO+GeO₂+TeO₂+Cr₂O₃+J ranges from >0.01 to 45 percent by weight or a glass ceramic or a glass powder or a glass ceramic powder produced from a glass of this composition in cosmetic or medicinal formulations, deodorant products, products in the field of paper hygiene, foods, detergents, paints and enamels, plasters, cements, concrete, oral hygiene products, dental care, palatine hygiene, palatine care.

Surprisingly, in the case of the inventive glasses or glass ceramics or glass powders or glass ceramic powders which are obtained proceeding from the above named glass composition a sufficient chemical resistance, a high reactivity and in particular a skin-neutral pH value are identified. On the basis of this skin-neutral pH value the glass is particularly well-suited for use in the cosmetic or medicinal field, in particular for medicinal or cosmetic formulations.

The glass, in particular however, the glass powder, exhibits either a biocidal effect, or at least a biostatic effect. On the basis of the skin-neutral, i.e. weakly acid pH value of 5.5 up to an especially preferred neutral pH value of 7 in the aqueous solution, the glass or the glass powder obtained from it or the glass ceramic obtained from it or the glass ceramic powder obtained from it in contact with human beings as well as glasses which show a high basic pH value for example among other things that glasses on a silicate basis are unsuitable.

In addition the glass is toxicologically generally recognized as safe, which is important particularly for medical or cosmetic applications. For applications in direct contact with human beings the load of the heavy metals is preferably less than 20 ppm for Pb, less than 5 ppm for Cd, less than 5 ppm for As, less than 10 ppm for Sb, less than 1 ppm for Hg, less than 10 ppm for Ni.

The only heavy metal which the glass composition comprises in such an application in contact with human beings is Zn. Slight Ag₂O contents can be included for the achievement of special effects.

In the use of the inventive glasses in the medicinal/cosmetic field the antimicrobial effect outward is achieved by the release of antimicrobial active substances, in particular ions such as zinc or silver.

In an especially preferred embodiment the heavy metal content can be reduced by means of the complete or partial replacement of Zn preferably by Ca, but also by Mg, Sr.

Upon contact with water there is an exchange of ions in the case of the inventive glass, or glass powder or glass ceramic or glass ceramic powder, for example an exchange of Na ions or of Zn or Ca ions between the glass surface and the liquid medium. In addition, there can also be a release of ions by means of dissolution processes.

The rate of dissolution of the glass can be set by means of variation of the network forming phosphate component specified here as P₂O₅ and the sulfur component, which is specified here as SO₃ in oxide form. Using sulfur as a network-forming component has the advantage that this component is not toxic to human beings. The release rate of biocidal ions is set by means of the exchange of ions and the dissolution of the glass.

By means of the purposeful introduction of Na₂O, as well as ZnO or CaO the network formation is interrupted and the reactivity of the glass is set, since in the case of high Na₂O content the network is looser and introduced biocidal acting ions such as Zn, Ag can be more easily transferred. Inventive glasses comprising CaO, in particular with a weight percentage greater than 5 percent by weight have proven to be especially preferable, since in the case of the presence of Ca the glass becomes bioactive. Especially preferred embodiments contain Ca and Zn in the ratio of 1:1 to 1:2 percent by weight.

In addition TiO₂ and ZrO₂ can be added to the glass composition. TiO₂ has ultraviolet-ray absorbing properties which can protect the polymer from yellowing and embrittlement. Preferred ranges for TiO₂ are 0.1-5 percent by weight, with especially preferred ranges being 0.1-2.0 percent by weight.

ZrO₂ is added to the glass composition to lower the tendency to crystallize. Moreover it is used to set the chemical resistance. Preferred ranges are ZrO₂ are 0.1-5 percent by weight, with especially preferred ranges being 0.1-2.0 percent by weight.

By means of the exchange of Na ions or Ca ions in aqueous solution the pH value can be set to a neutral value, for example pH 7 or by means of the addition of P₂O₅ it can also be shifted to a slightly acid condition, so that a skin-neutral pH value of pH=5.5 results.

If the P₂O₅ content is increased or if the network of the glass is varied by means of melting parameters such as the melting period, purity of the raw materials etc., e.g. by varying the amount of free OH groups of the phosphorous oxide, then a shift into slightly acid condition can also be achieved, so that a skin-neutral pH value of pH=5.5 results.

By means of the purposeful setting of the Na₂O content as well as of the CaO content in proportion to the content of the network forming components SO₃/P₂O₅ it is possible to precisely set the pH value of the glass in contact with water by means of variation of the glass composition. A setting is achieved over a broad pH value range of 5 to 8.

The biocidal or biostatic effect of the inventive glass or glass powder obtained from said inventive glass or the inventive glass ceramics or glass ceramic powders obtained from these original glasses is caused by the release of ions in a liquid medium, in particular in water. The glasses or the glass powders and glass ceramics obtained from said glasses exhibit a biocidal effect toward bacteria, fungi as well as viruses.

For applications in fields in which there is no direct contact with human beings the inventive glasses or glass powders or glass ceramics can also exhibit heavy metal ions in higher concentrations for the achievement of a particularly strong biocidal effect. Such heavy metal ions are Ag, Cu, Ge, Te and Cr. Glasses or glass powders or glass ceramics in accordance with the invention can be added to polymers, paints and enamels.

If the glass contains calcium and phosphor it can also possess a bioactive effect in addition to the biocidal effect. This is then based on the formation of hydroxyl apatite and takes place preferably in slightly alkaline condition.

In the case of the inventive glasses, glass powders, glass ceramics or glass ceramic powders alkalis such as Na or Ca of the glass are exchanged by H⁺ ions of the aqueous medium by reactions on the glass surface. The antimicrobial effect is consequently based among other things on a release of ions. The antimicrobial effect by means of ion exchange impairs cell growth.

Along with the transfer the antimicrobial glass surface introduced into the system also plays a role. The antimicrobial effect of the glass surfaces is also based on the presence of antimicrobial acting ions. Additionally however, it is also known that surface charges, i.e. the zeta potential of powders can have an antimicrobial effect in particular on Gram-negative bacteria. Thus an antimicrobial effect proceeds from positive surface charges to Gram-negative bacteria, since positive surface charges attract bacteria, but Gram-negative bacteria do not grow on surfaces with positive zeta potential, i.e. cannot multiply. In this regard reference is made to Bart Gottenbos et al. Materials in Medicine 10 (1999) pages 853-855 Surface of Polymers.

Antimicrobial effects in powders with positive surface charge are described in Speier et al. Journal of Colloid and Interface Science 89 68-76 (1982) Kenway et al. Journal of controlled release 50, 145-52 (1998).

The glasses described here also comprise glass ceramics or ceramics. These are manufactured by means of a subsequent annealing step either on the half-finished product (e.g. the ribbons) or on the product (for example powder or fibers). After the annealing step a renewed grinding may be necessary in order to set the desired particle size.

The antimicrobial effect is synergistically strengthened by means of the reactivity of the sulfur or phosphorus content in the inventive glass, whereby a bioactive effect can occur through the formation of hydroxyl-apatite layers, which enter into a firm bond with the body tissue.

With the help of grinding processes the glass compositions can be ground up to glass powder with particle sizes <100 μm. Particles sizes <50 μm or <20 μm have proved to be practical. Particles sizes <10 μm as well as smaller than 5 μm are particularly suitable. Particle sizes <2 μm have proven to be most particularly suitable. The grinding process can be conducted either dry or using non-aqueous or aqueous grinding media.

Mixtures of different glass powders from the composition range with different compositions and particle sizes are possible in order to combine specific effects.

Depending on the particle size, concentration and the composition of the powder pH values ranging from 5 to 8 are achieved.

Mixtures of glass powders with different compositions and particle sizes can be synergistically combined to set special properties of the individual glass powders. For example it is possible to control the antimicrobial effect of the glass powder by means of the particle size.

The glass of the glass powder contains SO₃ and P₂O₅ as a network forming ions. An SO₃ content of less than 17 percent by weight is especially preferred, because an especially preferred chemical resistance can be achieved with it, which is large enough to make possible a biocidal or biostatic effect over a long period of time.

Na₂O is used as a fluxing agent in the melting of the glass. In concentrations less than 8 percent by weight the melting behavior is negatively influenced. Moreover the necessary mechanism of the ion exchange is no longer sufficient in order to achieve an antimicrobial effect. In the case of Na₂O concentrations higher than 30 percent by weight a drastic deterioration of the chemical resistance is observed.

Alkaline oxides and alkaline earth oxides can be added in order to increase the exchange of ions and thus achieve an antimicrobial effect.

The amount of Al₂O₃ serves the purpose of increasing the chemical resistance of the crystallization stability.

ZnO is a significant component for the heat molding properties of the glass. It improves the crystallization stability and increases the surface tension.

In addition ZnO has an antimicrobial effect. Moreover, it can show anti-inflammatory and wound-healing effects for specific applications, in particular in direct contact with human beings e.g. in cosmetic and medicinal products. For the achievement of an antimicrobial and anti-inflammatory or wound-healing effect ZnO up to 45 percent by weight can be included.

The disinfecting and wound-healing effect can also be synergistically strengthened by the addition of iodine to the glass composition. In order to increase the antimicrobial effect of the base glass Ag₂O, CuO can also be added as antimicrobial acting additives.

The inventive glass does not cause any skin-irritating effects.

By means of Ag, Cu transfer a considerable increase of the antimicrobial effect can be achieved. The concentration of Ag, Cu ions released in the product can lie significantly below 1 ppm, since these components are not absolutely necessary for the antimicrobial effect of the glass. The introduction of Ag, Cu, Zn can either take place during the melting by means of appropriate salts or by means of ion exchange of the glass after the melting.

Depending on the application, components such as fluorine can be added to the glass in concentrations totaling to 5 percent by weight. This embodiment is used particularly in the field of dental care and dental hygiene, because along with the antimicrobial and anti-inflammatory effect, this embodiment makes it possible to release fluorine in slight concentrations, which hardens the dental enamel.

An especially preferred application in the dental field is the use of the described glasses for dental materials. In particular the inventive glasses are well suited either alone or in combination with other materials for fillings, crowns, inlets. The use of the inventive glasses or glass ceramics and the glass powders or glass ceramic powders obtained from said glasses as a composite material with polymer materials is especially preferred.

For the achievement of color effects single or even multiple color-bearing components such as e.g. Fe₂O₃, CoO, CuO, V₂O₅, Cr₂O₅ in a total concentration less than 4 percent by weight, preferably less than 1 percent by weight can be added to the glasses.

Glasses, glass powders, glass ceramics or glass ceramic powders with a composition lying within the claimed composition range fulfill all requirements with regard to use in the areas of paper hygiene, cosmetics, paints, enamels, plasters, medical products, cosmetic applications, food additives as well as use in deodorant products, antiperspirants as well as in products for the treatment of skin irritations, acute and chronic wounds.

Without limiting the use of the described glasses in the polymer range, there are polymers that are especially well suited to the addition of bioglass. This are in particular PMMA; PEEK; PVC; PTFE; polystyrene; polyacrylate; polyethylene; polyester; polycarbonate; PGA biodegradable polymer; LGA biodegradable polymer or the biopolymer collages; fibrin; chitin; chitosan; polyamide; polycarbonate; polyester; polyimide; polyurea; polyurethane; organic fluorocarbon polymers; polyacrylamide and polyacrylic acids; polyacrylates; polymethacrylate; polyolefin; polystyrene and styrene co-polymers; poly vinyl ester; poly vinyl ether; poly vinylidene chloride; vinyl polymers; poly oxymethylene; poly aziridine; polyoxyalkylene; synthetic resin or alkyl resin, amino resin, epoxy resin, phenolic resin or unsaturated polyester resin; electric conducting polymers; high temperature polymers; inorganic polymers; poly phenylene oxide silicone; biopolymers such as cellulose, cellulose ester, cellulose ether, enzyme, gelatin, natural resin, nucleic acids, polysaccharides, proteins, silk, starch or wool. Preferably the inventive glasses possess low alkali content for use with alkali-sensitive polymers, such as e.g. polycarbonates. In particular the antimicrobial glasses described here are suitable for use in the following products, for example as an antimicrobial additive in polymers:
Cutting boards
Gloves
Garbage cans
Knife handles
Silverware, for example chopsticks
Trays
Table covers
Refrigerators
Rinsing machines
Tumble dryers
Washing machines
Telephones
Keyboards
Irons
Rice cookers
Steering wheels
Automobile instruments
Armrests
Keys
Door handles
Ash trays
Gear shift handle grips
Switches
Ballpoint pens
Diskettes
Audio/Video cassettes
Compact disks (CD)
Clipboards

In addition such glasses, glass ceramics, glass powders or also glass ceramic powders can also be used in the area of the clothing industry, preferably as an additive to synthetic fibers. A use in:
Clothing
Socks
Underwear
Hand towels
Toilet cloths
Wallpaper
Pillowcases
Pillow stuffing
Swim wear
Bathing caps
   is conceivable.

Additional products based on synthetic fiber or polymer which can contain the inventive glass, the inventive glass ceramic, a glass powder or glass ceramic powder obtained from said inventive glass or glass ceramic are:
Carpeting
Contact lens
Contact lens holders
Play sand
Plastic money
Paper money
Toys
Wristwatches
Diving gear
   The antimicrobial glass powder as an admixture to the fibers is especially suitable in particular for use in fibers for carpeting.

One property of the glass, the glass ceramic, the glass powder or the glass ceramic powder is its surprising proven skin compatibility, to be precise, even in high concentrations.

The glass, the glass ceramic, the glass powder or glass ceramic powder can be used in any suitable form. Mixtures of different glass powders from the composition range with different compositions are also possible. Mixture with other glass powders and/or glass ceramic powders is also possible to combine specific effects.

Depending on the application, components such as fluorine can be added to the glass in concentrations totaling to 5 percent by weight.

The glass described in this invention or the glass ceramics or the glass powder or the glass powder ceramic obtained from said glass, which is obtained by means of grinding, is water soluble, but possesses sufficient chemical stability. The glass or glass powder acts first and foremost by means of ion exchange or ion transfer, which is connected with a surface reaction, pH increase and metal ion release.

Surprisingly the glass powders or glass ceramic powders in accordance with the invention evince a high reactivity, a high hydrolytic resistance and a higher antimicrobial effect than the group of bioactive glasses which were described in the state of the art or glass powders that were manufactured from such glasses.

In the following the invention will be described with the help of the embodiments. In the specified embodiments a glass was melted from the raw materials in a quartz glass crucible, and then processed into ribbons. The ribbons were further processed into powder with a particle size d50=4 μm by means of dry grinding.

In Table 1 the compositions and properties of glasses are given which can be grounded into the inventive glass powders and which exhibit an antimicrobial effect. The compositions refer to synthetic values in percent by weight on an oxide basis.

TABLE 1
Compositions (synthetic values) [percent by weight] of Inventive
glass compositions containing alkalis:

| | Embod. | Embod. | Embod. | Embod. | Embod. | Embod. | Embod. | Embod. | Embod. | Em [symbol] |
|---|---|---|---|---|---|---|---|---|---|---|
| | 1 | 2 | 3 | 4 | 5 | 6 | 7 | 8 | 9 | 10 |
| P₂O₅ | 33.5 | 32.5 | 35 | 35.9 | 32.5 | 32.5 | 32.5 | 35 | 31.7 | 31. [symbol] |
| SO₃ | 15 | 15 | 16 | 14 | 15 | 15 | 15 | 15 | 18.6 | 18. [symbol] |
| B₂O₃ | | | | | | | | | | |
| Al₂O₃ | | | | | | | | | | |
| SiO₂ | | | | | | | | | | |
| Li_{2O} | | | | | | | | | 1.6 | 1.6 |
| Na₂O | 14.6 | 14.6 | 12.999 | 14.6 | 14.5 | 14.6 | 14.6 | 15 | 6.6 | 6.6 |
| K₂O | | | | | | | | | 7.5 | 7.5 |
| CaO | 3.3 | 3.3 | 2.4 | 35 | 11 | 3.3 | 3.3 | 10 | 1.0 | 1.0 |
| MgO | | | | | | | | | | |
| SrO | | | | | | | | | | |
| BaO | | | | | | | | | | |
| ZnO | 33.6 | 33.6 | 33.6 | | 26.5 | 33.6 | 33.6 | 25 | 33 | 32. [symbol] |
| Ag₂O | | 1 | 0.001 | 0.5 | 0.5 | 0.1 | | | | 1.5 |
| CuO | | | | | | 0.3 | | | | |
| GeO₂ | | | | | | | | | | |
| TeO₂ | | | | | | | | | | |
| Cr₂O₃ | | | | | | 0.6 | | | | |
| J | | | | | | | 1 | | | |

The following Table 2 shows pH values and conductivities of glass powders of the composition as found in Embodiments 1 and 2 as per Table 1 in a 1 percent by weight aqueous suspension after 60 min.:

TABLE 2

| Glass | | |
|---|---|---|
| composition | Embod. 1 | Embod. 2 |
| Ph value | 7.2 | 7.2 |
| Conductivity | 143 | 94 |
| (μS/cm) | | |

In Table 3 the antimicrobial effect for Embodiment 2 as per Table 1 is given whereby 0.001 percent by weight of glass powder with a mean particle size of 4 μm was measured in an aqueous suspension. The start value in Table 3 indicates the number of bacteria used at the beginning, for example 250,000 E. coli bacteria. A value of 0 is the proof of the antimicrobial effect of the suspension containing the inventive glass powder.

TABLE 3
Antibacterial effect of the powders according to Europ.
Pharmakopoe (3^{rd} Edition) in 0.001 percent by
weight of a glass powder as per Embodiment 2 with a
mean particle size of 4 μm in an aqueous suspension:

| | | P. | | | |
|---|---|---|---|---|---|
| | E. coli | aeruginosa | S. aureus | C. albicans | A. niger |
| Start | 250,000 | 320,000 | 330,000 | 300,000 | 310,000 |
| 2 days | 0 | 0 | 0 | 0 | 0 |
| 7 days | 0 | 0 | 0 | 0 | 0 |
| 14 days | 0 | 0 | 0 | 0 | 0 |
| 21 days | 0 | 0 | 0 | 0 | 0 |
| 28 days | 0 | 0 | 0 | 0 | 0 |

Table 4 shows the antimicrobial effect of a glass powder as per Embodiment 2 in a 0.1 percent by weight aqueous suspension.

TABLE 4
Antibacterial effect of the powders according to Europ.
Pharmakopoe (3^{rd} Edition) in 0.1 percent by weight
of a glass powder as per Embodiment 7 with a mean
particle size of 4 μm in an aqueous suspension:

| | | P. | | | |
|---|---|---|---|---|---|
| | E. coli | aeruginosa | S. aureus | C. albicans | A. niger |
| Start | 250,000 | 320,000 | 330,000 | 300,000 | 310,000 |
| 2 days | 12,000 | 800 | 6,000 | 164,000 | 180,000 |
| 7 days | 0 | 0 | 0 | 210,000 | 120,000 |
| 14 days | 0 | 0 | 0 | 25,000 | 100,000 |

Subsequently the antimicrobial effectiveness of a glass powder with a particle size of d50 of 4 μm and a glass composition in accordance with Embodiment 1 in Table 1 is described in a proliferation test.

A proliferation test is a test method with whose help the effectiveness of antimicrobial surfaces can be quantified. In the process, simply put, the antimicrobial effectiveness of the surface is characterized as to whether and how many daughter cells are transferred to a surrounding nutrient medium. The performance of the test is described in T. Bechert, P. Steinrücke, G. Guggenbichler, Nature Medicine, Volume 6, Number 8, September 2000, Pages 1053-1056. The disclosure of this publication is included in its entirety in the present application.

The glass powder was homogenously introduced into one polymer. The polymer used was polypropylene (PP).

Staphylococcus epidermidis was used as the germ. This germ is a bacterium which occurs on the skin.

In Table 5 the observed proliferation over 48 hours is shown for a glass powder with a particle size between d50 of 4 m and a glass composition in accordance with Embodiment 1, which was homogenously introduced in the specified concentrations (percent by weight) into polypropylene (PP).

TABLE 5
Results of the proliferation test in dependency on the amount of glass
powder in PP.

| | | | | |
|---|---|---|---|---|
| Glass powder | 0.20% | 0.50% | 2.00% | 5.00% |
| amount in | | | | |
| percent by | | | | |
| weight | | | | |
| Onset OD | 5 | 16 | 15.8 | 34.3 |
| (absolute) | | | | |
| Assessment | Very slightly | antibacterial | antibacterial | highly |
| | antibacterial | | | antibacterial |

By Onset OD the optical density in the surrounding nutrient medium is meant. By means of proliferation (formation of daughter cells) and transfer of the cells from the surface to the surrounding nutrient medium an impairment of the transmission of the nutrient medium takes place. This absorption with specified wavelengths correlates with the antimicrobial effectiveness of the surface. The higher the Onset OD value, the more strongly antimicrobially effective the surface is.

With the invention an antimicrobial glass composition is specified for the first time which contains SO₃ as a network forming ion and which exhibits an antimicrobial effect. The glass possesses, in comparison to a phosphate glass with corresponding chemical resistance, a lower Tg, i.e., transformation temperature of the glass and VA, i.e. processing temperature, and is consequently simpler in production as well as processing. With regard to the term transformation temperature, reference is made to the VDI-Lexikon, Werkstoff-Technik, (1993), pages 375-376. Additionally, in the compounding with polymers it can partially melt and thus produce a better bond between polymer and glass.

1. Antimicrobial and anti-inflammatory acting sulfophosphate glass with the following composition in percent by weight on an oxide basis:

| | | |
|---|---|---|
| P₂O₅ | 15-60 | percent by weight |
| SO₃ | 5-40 | percent by weight |
| B₂0₃ | 0-20 | percent by weight |
| Al₂O₃ | 0-10 | percent by weight |
| SiO₂ | 0-10 | percent by weight |
| Li₂O | 0-25 | percent by weight |
| Na₂O | 0-25 | percent by weight |
| K₂O | 0-25 | percent by weight |
| CaO | 0-40 | percent by weight |
| MgO | 0-15 | percent by weight |
| SrO | 0-15 | percent by weight |
| BaO | 0-15 | percent by weight |
| ZnO | 0-45 | percent by weight |
| Ag₂O | >0.01-5 | percent by weight |
| CuO | 0-10 | percent by weight |
| GeO₂ | 0-10 | percent by weight |
| TeO₂ | 0-15 | percent by weight |
| Cr₂O₃ | 0-10 | percent by weight |
| J | 0-10 | percent by weight |
| F | 0-5 | percent by weight |

whereby the sum ZnO+Ag₂O+CuO+GeO₂+TeO₂+Cr₂O₃+J ranges from >0.01 to 45 percent by weight.

2. Antimicrobial and anti-inflammatory acting sulfophosphate glass with the following composition in percent by weight on an oxide basis:

| | | |
|---|---|---|
| P₂O₅ | 15-60 | percent by weight |
| SO₃ | 5-40 | percent by weight |
| B₂0₃ | 0-20 | percent by weight |
| Al₂O₃ | 0-10 | percent by weight |
| SiO₂ | 0-10 | percent by weight |
| Li₂O | 0-25 | percent by weight |
| Na₂O | 0-25 | percent by weight |
| K₂O | 0-25 | percent by weight |
| CaO | >7.7-45 | percent by weight |
| MgO | 0-15 | percent by weight |
| SrO | 0-15 | percent by weight |
| BaO | 0-15 | percent by weight |
| ZnO | 0-45 | percent by weight |
| Ag₂O | 0-5 | percent by weight |
| CuO | 0-10 | percent by weight |
| GeO₂ | 0-10 | percent by weight |
| TeO₂ | 0-15 | percent by weight |
| Cr₂O₃ | 0-10 | percent by weight |
| J | 0-10 | percent by weight |
| F | 0-5 | percent by weight |

whereby the sum ZnO+Ag₂O+CuO+GeO₂+TeO₂+Cr₂O₃+J ranges from >0.01 to 45 percent by weight.

3. Antimicrobial and anti-inflammatory acting sulfophosphate glass in accordance with claim 1, characterized by the fact that the glass composition contains in particular more than ZnO 5 percent by weight, in particular more than ZnO 10 percent by weight, in particular preferably more than ZnO 24 percent by weight, especially preferably more than ZnO 30 percent by weight.

4. Antimicrobial and anti-inflammatory acting sulfophosphate glass in accordance with claim 1, characterized by the fact that the glass composition comprises more than SO₃ 7 percent by weight, in particular more than SO₃ 9 percent by weight, and most particularly more than SO₃ 11 percent by weight.

5. Antimicrobial and anti-inflammatory acting sulfophosphate glass in accordance with claim 1, characterized by the fact that the glass composition comprises Ag₂O in the range of 0.001-5 percent by weight.

6. Antimicrobial and anti-inflammatory acting sulfophosphate glass in accordance with claim 1, characterized by the fact that the glass composition comprises Ag₂O 0.1-5 percent by weight.

7. Antimicrobial and anti-inflammatory acting sulfophosphate glass in accordance with claim 1, characterized by the fact that the glass composition comprises CuO >0.01-10 percent by weight.

8. Antimicrobial and anti-inflammatory acting sulfophosphate glass in accordance with claim 1, characterized by the fact that the sum ZnO+CaO ranges from 20 percent by weight-60 percent by weight.

9. Antimicrobial and anti-inflammatory acting sulfophosphate glass ceramic, characterized by the fact that the original glass is a glass in accordance with claim 1.

10. Antimicrobial acting glass powder or glass ceramic powder, characterized by the fact that the glass powder comprises a glass with a glass composition in accordance with claim 1.

11. Antimicrobial acting glass powder or glass ceramic powder in accordance with claim 10, characterized by the fact that the size of the glass particles of the powder on the average is <20 μm.

12. Antimicrobial acting glass powder or glass ceramic powder in accordance with claim 10, characterized by the fact that the size of the glass particles of the powder on the average is <10 μm.

13. Antimicrobial acting glass powder or glass ceramic powder in accordance with claim 10, characterized by the fact that the size of the glass particles of the powder on the average is <5 μm.

14. Antimicrobial acting glass powder or glass ceramic powder in accordance with claim 10, characterized by the fact that the size of the glass particles of the powder on the average is <1 μm.

15. Antimicrobial acting glass or glass ceramic or glass powder or glass ceramic powder in accordance with claim 1 for use in cosmetic products.

16. Antimicrobial acting glass or glass ceramic or glass powder or glass ceramic powder in accordance with claim 1 for use in deodorant products.

17. Antimicrobial acting glass or glass ceramic or glass powder or glass ceramic powder in accordance with claim 1 for use in medicinal products and preparations.

18. Antimicrobial acting glass or glass ceramic or glass powder or glass ceramic powder in accordance with claim 1 for use in plastics and polymers.

19. Antimicrobial acting glass or glass ceramic or glass powder or glass ceramic powder in accordance with claim 1 for use in the field of paper hygiene.

20. Antimicrobial acting glass or glass ceramic or glass powder or glass ceramic powder in accordance with claim 1 for use in foods.

21. Antimicrobial acting glass or glass ceramic or glass powder or glass ceramic powder in accordance with claim 1 for use in detergents.

22. Antimicrobial acting glass or glass ceramic or glass powder or glass ceramic powder in accordance with claim 1 for use in paints and enamels.

23. Antimicrobial acting glass or glass ceramic or glass powder or glass ceramic powder in accordance with claim 1 for use in plasters, cements and concrete.

24. Antimicrobial acting glass or glass ceramic or glass powder or glass ceramic powder in accordance with claim 1 for use in products of oral hygiene, dental care, oral care, palatine hygiene, palatine care.

25. Use of a glass with the following composition:

| | | |
|---|---|---|
| P₂O₅ | 15-60 | percent by weight |
| SO₃ | 5-40 | percent by weight |
| B₂0₃ | 0-20 | percent by weight |
| Al₂O₃ | 0-10 | percent by weight |
| SiO₂ | 0-10 | percent by weight |
| Li₂O | 0-25 | percent by weight |
| Na₂O | 0-25 | percent by weight |
| K₂O | 0-25 | percent by weight |
| CaO | 0-40 | percent by weight |
| MgO | 0-15 | percent by weight |
| SrO | 0-15 | percent by weight |
| BaO | 0-15 | percent by weight |
| ZnO | 0-45 | percent by weight |
| Ag₂O | 0-5 | percent by weight |
| CuO | 0-10 | percent by weight |
| GeO₂ | 0-10 | percent by weight |
| TeO₂ | 0-15 | percent by weight |
| Cr₂O₃ | 0-10 | percent by weight |
| J | 0-10 | percent by weight |
| F | 0-5 | percent by weight |

whereby the sum ZnO+Ag₂O+CuO+GeO₂+TeO₂+Cr₂O₃+J ranges from >0.01 to 45 percent by weight, or of a glass ceramic or a glass powder or a glass ceramic powder produced from a glass of this composition for cosmetic or medicinal products, deodorant products, products in the field of paper hygiene, foods, detergents, paints and enamels, plasters, cements, concrete, oral hygiene products, dental care products, palatine hygiene products, palatine care products.

25. Cosmetic formulation comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

26. Medicinal formulation comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

27. Deodorant comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

28. Products in the field of paper hygiene comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

29. Food comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

30. Detergent comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

31. Paints and enamels comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

32. Plasters, cements, concrete comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

33. Products of oral hygiene, dental care, palatine hygiene, palatine care comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+AgO+CuO+GeO₂+TeO₂+Cr₂O₃+J ranges from >0.01 to 45 percent by weight.

34. Plastic product, in particular polymers, in particular synthetic fibers comprising at least 0.2 percent by weight of a glass, a glass ceramic, a glass powder or a glass ceramic powder, whereby the glass or the original glass of the glass ceramic comprises the following composition:

| | |
|---|---|
| P₂O₅ | 15-60 percent by weight |
| SO₃ | 5-40 percent by weight |
| B₂0₃ | 0-20 percent by weight |
| Al₂O₃ | 0-10 percent by weight |
| SiO₂ | 0-10 percent by weight |
| Li₂O | 0-25 percent by weight |
| Na₂O | 0-25 percent by weight |
| K₂O | 0-25 percent by weight |
| CaO | 0-40 percent by weight |
| MgO | 0-15 percent by weight |
| SrO | 0-15 percent by weight |
| BaO | 0-15 percent by weight |
| ZnO | 0-45 percent by weight |
| Ag₂O | 0-5 percent by weight |
| J | 0-10 percent by weight |
| F | 0-5 percent by weight |

whereby the sum ZnO+Ag₂O+CuO+GeO₂+TeO₂+Cr₂O₃+J ranges from >0.01 to 45 percent by weight.

35. Antimicrobial acting glass powder or glass ceramic powder, characterized by the fact that the glass powder comprises a glass with a glass ceramic in accordance with claim 9.
